(19) United States
(12) Patent Application Publication
(10) Pub. No.: US 2026/0284935 A1
(43) Pub. Date: Sep. 24, 2026

(54) METHOD FOR PRODUCING GRANULATED MATERIAL FOR CHEMICAL RECYCLING, AND GRANULATED MATERIAL FOR CHEMICAL RECYCLING

(71) Applicants: JGC Corporation, Kanagawa (JP); Teijin Limited, Osaka (JP)

(72) Inventors: Akiko ITO, Kanagawa (JP); Yasuhiro ANDO, Kanagawa (JP); Koji TANAKA, Kanagawa (JP); Masatoshi FURUKAWA, Kanagawa (JP); Koji KOYANO, Kanagawa (JP); Nobuyoshi MIYASAKA, Osaka (JP)

(21) Appl. No.: 19/474,549

(22) PCT Filed: Feb. 28, 2024
(86) PCT No.: PCT/JP2024/007370

§ 371 Date: Oct. 10, 2025

(30) Foreign Application Priority Data
Apr. 11, 2023 (JP) 2023-064362

(51) Int. Cl. B29B 17/04; B29K 67/00

(52) U.S. Cl. CPC B29B 17/0412; B29B 2017/0468; B29K 2067/00; B29K 2995/0063

(57) ABSTRACT

Provided are: a method for forming a polyester waste into a granulated material that is suitable for a depolymerization process in chemical recycling of the polyester waste; and the granulated material for chemical recycling. This method for producing a granulated material for chemical recycling includes: crushing a polyester waste; melt-extruding the pulverized polyester waste; solidifying the melt-extruded polyester waste by means of air cooling; and forming a granulated material by crushing the solidified polyester waste.

### TECHNICAL FIELD

The present disclosure relates to a method for producing a granulated material for chemical recycling, and a granulated material for chemical recycling.

### BACKGROUND ART

Since polyesters such as polyethylene terephthalate (PET) are excellent in chemical stability, a large amount of polyesters has been produced and used as life-related materials such as fibers, films, and containers, and in food fields such as bottles for drinking water or carbonated beverages. Various attempts have been made to recycle wastes generated in the production and use of polyester.

Recycling of polyester wastes is roughly classified into three categories, such as material recycling, thermal recycling, and chemical recycling.

Material recycling involves converting polyester wastes into low-quality materials by melt molding. In material recycling, it is finally difficult to avoid disposal because repeated recycling results in further degradation in quality.

Thermal recycling includes reusing the heat of combustion generated during the incineration of polyester wastes. Thermal recycling does not allow for recycling in the form of polyester or raw materials thereof, and carbon dioxide is also generated by incineration.

Therefore, it is not always desirable from the viewpoint of resource saving and environmental conservation.

Chemical recycling includes depolymerizing polyester contained in a polyester waste to convert the polyester waste into a monomer that is a constituent unit of the polyester and reusing the resulting monomer in polyester synthesis. One method for chemical recycling of a polyester waste includes, for example, a glycolysis-transesterification method including depolymerization (alcoholysis degradation) of a polyester waste in the presence of ethylene glycol (EG) to produce bis-2-hydroxyethyl terephthalate (BHET) and a subsequent transesterification reaction of BHET with methanol into dimethyl terephthalate (DMT) and ethylene glycol. Chemical recycling can synthesize polyester again without degrading quality, thus enabling resource reuse in the original sense.

PTL 1 (JP 2003-128626 A) discloses “a method for recovering terephthalic acid from a polyester waste, the method including, when terephthalic acid is recovered from a polyester fiber waste substantially consisting of a polyalkylene terephthalate fiber and a natural fiber and/or a chemical fiber other than the polyalkylene terephthalate fiber, a pretreatment step of analyzing the polyester fiber waste by a discrimination device, crushing and granulating a material that is discriminated as a polyester to form a crude polyester, and transporting the crude polyester to a reaction step; and a reaction step including the following steps (a) to (j)”, wherein the steps (a) to (i) are (a) a depolymerization step, (b) a foreign matter removal step, (c) a filtration separation step, (d) a concentration step, (e) a transesterification step, (f) a purification step, (g) a hydrolysis reaction step, (h) a separation step, (i) a substitution step, and (j) a slurry adjustment step.

PTL 2 (JP 2021-533211 A) discloses “a method for recovering a waste polyester material including: a material pretreatment step of dehydrating and deoxygenating a waste polyester material to obtain a waste polyester raw material; a melting and feeding step of melting the waste polyester raw material to obtain a waste polyester in a molten state, continuously feeding the waste polyester in a molten state in an alcoholysis vessel, and during the melting process of the waste polyester raw material, adding ethylene glycol, which is an alcohololysis agent, to perform the alcohololysis; an alcoholysis step of depolymerizing the waste polyester in a molten state, the alcohololysis agent, and an alcohololysis catalyst in the alcoholysis vessel to obtain an alcoholyzed product; and a transesterification step of transesterifying a transesterification agent, a transesterification catalyst, and the alcoholyzed product in a transesterification vessel”.

### CITATION LIST

### Patent Literature

PTL 1: JP 2003-128626 A
PTL 2: JP 2021-533211 A

### SUMMARY OF INVENTION

### Technical Problem

It is desirable that the polyester waste be crushed and granulated before the depolymerization step from the viewpoint of handleability and filling efficiency into a reactor. Meanwhile, since the depolymerization reaction is a solid-liquid heterogeneous phase reaction between a solid polyester and a liquid ethylene glycol, the shape and physical properties of the granulated material of the polyester waste greatly affect the reaction efficiency of the depolymerization reaction.

The present disclosure provides a method for forming a polyester waste into a granulated material suitable for a depolymerization step in chemical recycling of the polyester waste, and such a granulated material for chemical recycling.

### Solution to Problem

The inventors found that a granulated material with high reactivity in a depolymerization reaction and excellent handleability and filling efficiency into a reactor can be obtained by melt-extruding crushed polyester waste and then solidifying the melt-extruded product by air cooling and have completed the present invention.

The present disclosure encompasses the following aspects:

### Aspect 1

A method for producing a granulated material for chemical recycling, the method including:
crushing a polyester waste;
melt-extruding the crushed polyester waste;
solidifying the melt-extruded polyester waste by air cooling; and
crushing the solidified polyester waste to form a granulated material.

### Aspect 2

The method according to Aspect 1, wherein the melt extrusion and the solidification are performed using a plastcompactor.

### Aspect 3

The method according to Aspect 1 or 2, further including classifying the granulated material.

### Aspect 4

The method according to Aspect 3, further including reusing, in the melt extrusion, residues resulting from the classification.

### Aspect 5

The method of any one aspect of Aspects 1 to 4, wherein a ratio of apparent density to bulk density (apparent density/bulk density) of the granulated material is 1.80 to 2.40.

### Aspect 6

The method according to any one aspect of Aspects 1 to 5, wherein the granulated material has an apparent density of 1.23 g/cm³ to 1.33 g/cm³ and a bulk density of 0.60 g/cm³ to 0.67 g/cm³.

### Aspect 7

The method according to any one aspect of Aspects 1 to 6, wherein the granulated material has a closed cavity therein.

### Aspect 8

A granulated material for chemical recycling, the granulated material including a compressed solidified product of a polyester waste, and
having a ratio of apparent density to bulk density (apparent density/bulk density) of 1.80 to 2.40.

### Aspect 9

The granulated material for chemical recycling according to Aspect 8, wherein the granulated material has an apparent density of 1.23 g/cm³ to 1.33 g/cm³ and a bulk density of 0.60 g/cm³ to 0.67 g/cm³.

### Aspect 10

The granulated material for chemical recycling according to Aspect 8 or 9, the granulated material having a particle size of 10 mm or less and a content of the granulated material with a particle size of 900 μm or less of 0.2% by mass or less.

### Aspect 11

The granulated material for chemical recycling according to any one of Aspects 8 to 10, wherein the granulated material has a closed cavity therein.

### Advantageous of Effects of Invention

The present invention provides a granulated material for chemical recycling of a polyester waste with high reactivity in a depolymerization reaction and excellent handleability and filling efficiency into a reactor.

Note that the above description must not be regarded as disclosing all embodiments of the present invention and all advantages relating to the present invention.

### BRIEF DESCRIPTION OF DRAWINGS

FIG. 1 is a graph showing the depolymerization reactivity of samples of Example 1, Comparative Example 1, and Comparative Example 2.

FIG. 2 is a photograph of the granulated material of Example 1.

FIG. 3 is a photograph of the granulated material of Comparative Example 1.

### DESCRIPTION OF EMBODIMENTS

Representative embodiments of the present invention are described in more detail below for illustrative purposes, but the present invention is not limited to these embodiments.

In the present disclosure, true density, apparent density, and bulk density are defined by the equations below in accordance with the definition of JIS R 1634:1998. The external volume is a total volume including closed pores and open pores, as well as the solid portion of a sample. The apparent volume is a volume in which open pores are excluded from the external volume of a sample. If there are closed cavities (closed pores) inside the particle, the apparent density is smaller than the true density. If there are no closed cavities (closed pores) inside the particle, the apparent density is approximately equal to the true density, regardless of the presence or absence of cavities (open pores) communicating with the outside on the particle surface.

$$True density ( g / {cm}^{3} ) = mass of sample ( g ) / volume occupied only by sample ( {cm}^{3} )$$

$$Apparent density ( g / {cm}^{3} ) = mass of sample ( g ) / apparent volume of sample ( {cm}^{3} )$$

$$Bulk density ( g / {cm}^{3} ) = mass of sample ( g ) / external volume of sample ( {cm}^{3} )$$

### [Method for Producing Granulated Material for Chemical Recycling]

A method for producing a granulated material for chemical recycling in one embodiment includes:
crushing a polyester waste;
melt-extruding the crushed polyester waste;
solidifying the melt-extruded polyester waste by air cooling; and
crushing the solidified polyester waste to form a granulated material.

### <Crushing Step>

The form of the polyester waste is not particularly limited, and examples thereof include those discharged as industrial wastes or used materials or products, such as a carpet, carpet fiber, yarn, woven fabric, knitted fabric, string, rope, twisted yarn, a filling material, a filtration medium, a bottle, and a film. The polyester waste may include waste, excess, and the like that are generated during the production of products.

Examples of polyesters contained in the polyester waste include polyethylene terephthalate (PET), polytrimethylene terephthalate (PTT), and polybutylene terephthalate (PBT). Preferable polyester contained in the polyester waste is PET.

The polyester waste may include dissimilar materials, such as nylon, polyethylene, polypropylene, or cotton, in addition to polyesters, but these dissimilar materials do not participate in chemical recycling. The content of the polyester in the polyester waste is preferably 90% by mass or more, more preferably 95% by mass or more, and still more preferably 97% by mass or more. A polyester waste with a low polyester content may be eliminated at the raw material acceptance stage. For example, the composition of a polyester waste may be analyzed from the absorption pattern obtained using a near-infrared spectrometer or the like, and the polyester waste not having the desired composition may be eliminated without transporting such a polyester waste to the next step.

The polyester waste is crushed to a size that can be charged into an extruder in the melt-extrusion step. The size of the crushed material can be set as appropriate in accordance with the type of extruder, and is usually 2 mm to 15 mm. Crushing can be performed using, for example, a single-screw crusher. The crusher may be a two-stage type crusher, so as to increase crushing processing efficiency. When using a two-stage type crusher, for example, the polyester waste is roughly crushed to a size of 30 mm to 150 mm by a primary crusher and then crushed to a size of 2 mm to 15 mm by a secondary crusher. In the present disclosure, the size of the crushed material is defined by the minimum aperture of a metal mesh within the range through which the crushed material can pass when the crushed material is allowed to fall freely onto the mesh. For example, the size of the crushed material passing through a 15-mm square metal mesh is 15 mm or less, and the size of the crushed material not passing through a 2-mm square metal mesh is more than 2 mm.

### <Melt-Extrusion Step>

The crushed polyester waste is then melt-extruded. The polyester waste is compressed by the melt extrusion into a state suitable for the formation of granulated material. The melt-extrusion can be performed using a common single- or double-screw extruder. In the melt extrusion, at least the surface of the polyester waste is melted by frictional heat generated on the surface while the polyester waste moves in the barrel of the extruder under pressure, and the molten polyester functions as a binder to compress the polyester waste. The inner diameter of the barrel, screw shape, motor output, die shape, and the like of the extruder are suitably designed so that at least the surface of the polyester waste can melt.

The diameter of the melt-extruded product is preferably 2 mm to 20 mm, more preferably 3 mm to 15 mm, and still more preferably 4 mm to 10 mm. The diameter of the melt-extruded product is determined by the shape and dimensions of the opening of the die.

### <Air-Cooling Solidification Step>

The melt-extruded polyester waste is solidified by air cooling. Without being bound by any theory, when the melt-extruded polyester waste is solidified by air cooling, the surface solidification progresses slowly as compared to water cooling. The polyester waste that has been placed under pressure in the melt extrusion step is released to atmospheric pressure after the melt extrusion. Therefore, the evaporation of moisture or the like that may be present inside the melt-extruded product and the surface solidification of the melt-extruded product proceed competitively. It is therefore believed that cavities due to moisture remaining inside the melt-extruded product are formed inside the compressed solidified product formed by air-cooling solidification. In addition, air may enter the inside of the polyester waste in the step in which the polyester waste is melt-extruded, and the melt-extruded product is air-cooled and solidified with air contained therein, whereby cavities may be formed inside the compressed solidified product. Such internal cavities advantageously act in increasing the contact efficiency between the granulated material and ethylene glycol in the depolymerization reaction. In addition, the slow progress of the surface solidification allows fine irregularities or inlets to be present on the surface of the compressed solidified product, but the surface of the compressed solidified product is formed relatively smooth on a microscopic scale. This can increase the bulk density of the granulated material despite having cavities thereinside, that is, having relatively low apparent density, so that the handleability of the granulated material and the filling efficiency into a reactor can be enhanced. Furthermore, air-cooling solidification can reduce the moisture content remaining inside and on the surface of the granulated material, which can thus simplify or eliminate subsequent drying steps.

The air cooling may be performed by leaving the melt-extruded product as it is, or may be performed forcibly while applying a gas, such as air, to the melt-extruded product.

### <<Plastcompactor>>

The melt-extrusion and air-cooling solidification are preferably performed using a plastcompactor. Using a plastcompactor can stabilize physical properties of the granulated material, such as apparent density, bulk density, particle size, particle size distribution, and moisture content, regardless of the type of the polyester waste fed.

The plastcompactor is provided with a rotary compression disk and a fixed compression disk, and a compression region is defined between the rotary compression disk and the fixed compression disk. The fixed compression disk is in communication with the interchangeable kneading rail of the threaded joint. The crushed polyester waste is supplied from a supply silo to a kneading rail and continuously fed into the compression region of the plastcompactor through the center of the fixed compression disk. The polyester waste is quickly heated in the compression region by the friction due to contact with these compression disks and the friction inside the polyester waste. The heated polyester waste melts at least on the surface thereof and extends toward the outer periphery of the compression disk to form an elongate worm-like shape. The heating in the compression region further reduces the moisture content in the polyester waste. The elongated melt-extruded product protruding from the outer periphery of the compression disks of the plastcompactor falls while being air-cooled and collected into the collection device. The plastcompactor is commercially available, for example, from Herbold Meckesheim GmbH (Meckesheim, Baden-Württemberg, Germany) as the Plastcompactor HV series.

By melt-extrusion and air-cooling solidification using a plastcompactor, the diameter of the elongated melt-extruded product is generally determined on the basis of the width of the groove provided on the surface of the fixed compression disk. In addition, the heated polyester waste extends toward the outer periphery of the compression disk in contact with the groove, so that the surface of the melt-extruded product becomes relatively smooth. Therefore, by using the plastcompactor, a granulated material having uniform particle size and relatively smooth surface can be obtained. Such a granulated material has a small angle of repose and, therefore, exhibits excellent handling properties.

### <Granulated Material-Forming Step>

The solidified polyester waste (compressed solidified product) is transferred to a crusher using compressed air or the like and crushed so that a granulated material of the desired size can be formed. Crushing can be performed using, for example, a single-screw crusher. Crushing is preferably carried out so that the particle size of the granulated material is 10 mm or less.

### <Classification Step>

The resulting granulated material may be classified to obtain a granulated material having a narrower particle size distribution. The granulated material with a narrow particle size distribution is excellent in handleability and filling efficiency into a reactor.

Classification can be performed by a screening method. The granulated material exceeding the desired size can be separated and removed by a screening method, and the granulated material equal to or smaller than the desired size can be sent to the next step. The granulated material exceeding the desired size may be collected as a residue and returned to the crushing step again.

After classification by the screening method, the granulated material that is smaller than the desired size can be separated and removed using an air classifier, such as a zig-zag classifier, and a granulated material with a size equal to or greater than the desired size can be sent to the next step. The granulated material that is smaller than the desired size may be collected as a residue and recycled in the melt extrusion step.

### [Granulated Material for Chemical Recycling]

The granulated material for chemical recycling of one embodiment includes a compressed solidified product of a polyester waste. The ratio of apparent density to bulk density (apparent density/bulk density) of the granulated material is preferably 1.80 to 2.40, more preferably 1.84 to 2.22, and particularly preferably 1.92 to 2.10. When the ratio is 1.84 to 2.22, the granulated material can exhibit excellent handleability and filling efficiency into a reactor as described above, and, in addition, good depolymerization reactivity can be exhibited, as described below. If the value of the ratio deviates significantly from the above range due to too large or too small values of either apparent density or bulk density, the granulated material will not be able to achieve all of the above effects at a high level.

Without being bound by any theory, it is believed that the granulated material of this embodiment has closed cavities inside the granulated material because such a granulated material has a lower apparent density than polyester pellets. The closed cavities inside the granulated material are exposed as the depolymerization reaction progresses from the surface of the granulated material, so that the contact efficiency of the granulated material with ethylene glycol can be increased. Meanwhile, the granulated material is heavier than ethylene glycol (the specific gravity of ethylene glycol is 1.116 at 20° C.), so the granulated material precipitates in the reaction solution in the depolymerization step. This also contributes to increasing the contact efficiency of the granulated material with ethylene glycol.

In addition, because the granulated material of this embodiment has a relatively high bulk density, a larger amount of the granulated material can be conveyed and stored in a small space, and the granulated material is less likely to form bridges in a storage device, such as a hopper. Therefore, such a granulated material is also excellent in handleability and filling efficiency into a reactor. It is believed that the granulated material with a relatively high bulk density has a smooth surface with less unevenness and is less susceptible to the surface tension of the reaction solution. Thus, the granulated material of this embodiment is quickly acclimated to the reaction solution in the depolymerization step and is easily dispersed in the reaction solution. Furthermore, the granulated material reduces the solid-liquid volume ratio (solid volume/liquid volume) in the reaction solution, thereby reducing the load on the agitation power in the depolymerization step.

In the present disclosure, the apparent density of the granulated material is determined by a pycnometer method using helium gas. Specifically, the granulated material is put in a sample chamber of volume V_{C} (m³) at a temperature of 25° C., and the inside of the open pores of the granulated material is purged and replaced with helium gas by flowing helium gas into the sample chamber. After the completion of the replacement, the sample chamber is pressurized with helium gas to a pressure P₁ (Pa) that is equal to or higher than atmospheric pressure, and the sample chamber is tightly closed. When the pressure in the sample chamber is stabilized, the electromagnetic valve located downstream of the sample chamber is opened, then helium gas is allowed to flow into a comparison chamber of a volume V_{A} (m³), and the pressure P₂ (Pa) of the sample chamber and the comparative chamber is measured. The apparent volume V_{P} (m³) of the granulated material is calculated from the following equations using the ideal gas law. The apparent density of the granulated material is calculated from the obtained apparent volume and the mass of the granulated material.

$${P}_{1} ( {V}_{C} - {V}_{P} ) = {n}_{1} RT$$

$${P}_{2} ( {V}_{C} + {V}_{A} - {V}_{P} ) = {n}_{1} R T$$

$$↔ {P}_{1} ( {V}_{C} - {V}_{P} ) = {P}_{2} ( {V}_{C} + {V}_{A} - {V}_{P} )$$

$$↔ {V}_{P} = {V}_{C} - {V}_{A} / [ ( {P}_{1} / {P}_{2} ) - 1 ]$$

The apparent density of the granulated material is preferably 1.23 g/cm³ to 1.33 g/cm³, and more preferably 1.25 g/cm³ to 1.30 g/cm³.

In the present disclosure, the bulk density of the granulated material is determined from the mass of the granulated material entering the container of a predetermined volume. Specifically, the bulk density is calculated by filling the granulated material into a 1-L graduated cylinder at room temperature under normal pressure and determining the mass of the filled granulated material from the mass change before and after filling.

The bulk density of the granulated material is preferably 0.60 g/cm³ to 0.67 g/cm³, and more preferably 0.62 g/cm³ to 0.65 g/cm³.

In one embodiment, the granulated material has a closed cavity therein. The presence of a closed cavity therein can be observed by image analysis of an X-ray CT photograph.

The ratio of the apparent density of the granulated material to the true density of the polyester contained in the granulated material (apparent density of the granulated material/true density of the polyester) is preferably 0.90 to 0.99, more preferably 0.91 to 0.96. By setting the ratio to 0.90 or more, the granulated material is likely to sink in the reaction solution in the depolymerization step. As a result, the area where the reaction solution is in contact with the granulated material can be enlarged immediately after the granulated material is fed into the reaction solution thereby to promote the depolymerization reaction. By setting the ratio to 0.99 or less, depolymerization reactivity can be improved over PET resin pellets.

The particle size of the granulated material is preferably 10 mm or less. In the present disclosure, the particle size of the granulated material is the sieve diameter measured using a metal mesh sieve as specified in JIS Z 8801-1:2019. The particle size of the granulated material of 10 mm or less can enhance handling properties and filling efficiency into a reactor.

The content of the granulated material having a particle size of 900 μm or less is preferably 0.2% by mass or less. This can prevent the granulated material from scattering during handling and can also suppress the granulated material from floating on the surface of the reaction solution during the depolymerization step.

The granulated material of one embodiment is substantially free of binders. The wording “substantially free” herein means that the content of a binder is less than 1% by mass, preferably less than 0.5% by mass, and more preferably less than 0.1% by mass. Examples of the binder include thermoplastic resins such as polyethylene, polypropylene, an acrylonitrile-butadiene-styrene copolymer (ABS), and wood flour. The granulated material that is substantially free of binders can provide a monomer with less impurity after the depolymerization reaction.

### [Method for Using Granulated Material for Chemical Recycling]

The granulated material for chemical recycling can be suitably used for recycling polyester waste by a glycolysis-transesterification reaction method using ethylene glycol (EG).

The method for producing the granulated material for chemical recycling and the granulated material of the present disclosure are not limited to use in chemical recycling applications, but can be applied and used for other applications.

### EXAMPLES

While specific embodiments of the present disclosure are illustrated in the following examples, the present invention is not limited thereto. All parts and percentages, including tables, are represented by mass unless otherwise stated. Numerical values essentially include errors due to the principle of measurement and the measuring device. Values are presented as significant figures with normal rounding, including those listed in the tables.

### Example 1

The granulated material for chemical recycling of Example 1 was prepared according to the following procedure. A 100% polyester raw fabric and a 100% cotton raw fabric were mixed homogeneously, and a raw material containing 95% by mass of polyester and 5% by mass of cotton was prepared as an average value. The raw material was crushed to 15 mm or less, and the raw material was compressed and melted by frictional heat in a plastcompactor. The molten raw material was extruded between two disks with 5.2 mm-gap grooves, rotating at 425 rpm. The melt-extruded product passed through the groove was cut into an appropriate length by centrifugal force and rapidly cooled and solidified in air. The resulting compressed solidified product was crushed in a crusher to obtain a granulated material with a particle size of 10 mm or less. The granulated material of Example 1 had an apparent density of 1.291 g/cm³, a bulk density of 0.632 g/cm³, a particle size of 10 mm or less, and a content of the granulated material having a particle size of 900 μm or less of 0.2% by mass or less.

### Comparative Example 1

As Comparative Example 1, a granulated material prepared by melt-extruding a polyester waste, followed by rapid cooling in water (“pào pào liào” (swollen material), manufactured by ZHANGJIAGANG FIBRE MINGHONG MACHINERY FACTORY), was used. The granulated material of Comparative Example 1 had an apparent density of 1.335 g/cm³, a bulk density of 0.450 g/cm³, and a particle size of 40 mm or less. The granulated material of Comparative Example 1 had large unevenness formed on the surface when the granulated material was rapidly cooled in water, and also had a larger particle size distribution than the granulated material of Example 1.

### Comparative Example 2

As Comparative Example 2, PET resin pellets (semi-dull, manufactured by Zhejiang Jiaren New Materials Co., Ltd.) were used. The PET resin pellets of Comparative Example 2 had an apparent density of 1.345 g/cm³, a bulk density of 0.80 g/cm³, and a particle size of 7 mm or less.

The depolymerization reactivities of the granulated material of Example 1, the granulated material of Comparative Example 1, and the PET resin pellets of Comparative Example 2 were evaluated by the following procedure. A 1-L flask was charged with a sample and ethylene glycol in a mass ratio within the range of 1:2 to 1:3, and under the same conditions, the rotational speed was gradually increased to 200 rpm or 300 rpm using a single propeller blade as a stirring device, and the temperature of the mixture was raised to 190° C. while stirring the mixture. After continued stirring while maintaining the temperature of the mixture at 190° C., the depolymerization catalyst was added to the flask. The time point of catalyst addition was set at 0 min, and the reaction solution was sampled as needed while stirring was continued at 190° C. for 4 h, and the amount of bis(hydroxyethyl) terephthalate (BHET) in the flask was quantified by gas chromatography.

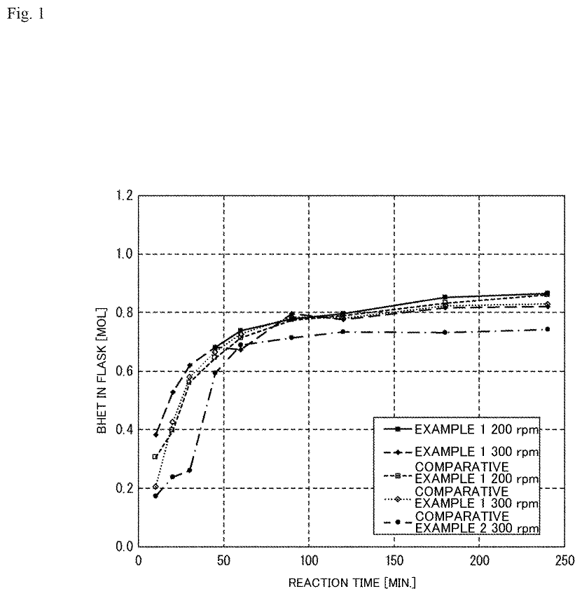

FIG. 1 shows a graph of the depolymerization reactivities of the samples of Example 1, Comparative Example 1, and Comparative Example 2. The horizontal axis represents the reaction time (min), and the time point of the catalyst feeding is 0 min. The vertical axis represents the amount of substance (mol) of BHET in the flask. When the catalyst is fed into the flask, depolymerization of the polyester progresses gradually, and the BHET increases rapidly again (0 min to 50 min). The depolymerization reaction rate (slope) in the initial stage of the reaction was comparable between Example 1 and Comparative Example 1. In contrast, the progress of the depolymerization reaction was slow in the initial stage of the reaction in Comparative Example 2. From these results, it can be seen that the granulated material for chemical recycling of Example 1 has an equivalent depolymerization reactivity to the granulated material of Comparative Example 1.

The granulated material for chemical recycling of Example 1 had a high bulk density, despite a low apparent density as compared to the granulated material of Comparative Example 1. Thus, the granulated material for chemical recycling of Example 1 exhibited excellent flow characteristics as a particulate material, and also had excellent handleability and filling efficiency into a reactor.

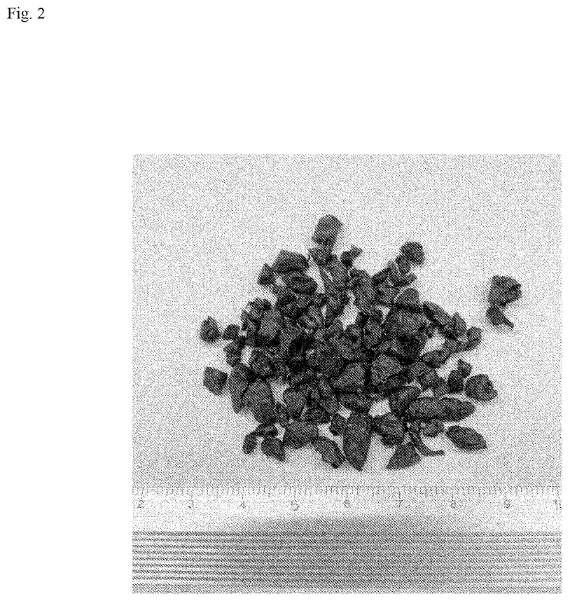

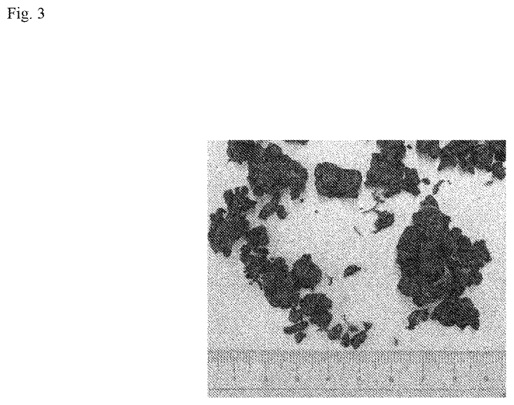

FIGS. 2 and 3 show photos of the granulated material of Example 1 and Comparative Example 1, respectively. As shown in FIG. 2, the granulated material for chemical recycling of Example 1 was uniform in particle size and relatively smooth in surface. Furthermore, the hardness that did not deform under a certain pressure was observed. In contrast, as shown in FIG. 3, the granulated material of Comparative Example 1 had, on the surface thereof, uneven portions formed by rapid water cooling, and it was easily deformed or disintegrated by external pressure, as compared to the granulated material for chemical recycling of Example 1.

It is apparent to a person skilled in the art that the above embodiments and examples are variously modifiable without departing from the basic principles of the present invention. It is also apparent to a person skilled in the art that various improvements and modifications of the present invention can be conducted without departing from the spirit and scope of the present invention.

### INDUSTRIAL APPLICABILITY

The method and granulated material of the present disclosure can be suitably used for chemical recycling of polyester wastes.

1. A method for producing a granulated material for chemical recycling, the method comprising:
crushing a polyester waste;
melt-extruding the crushed polyester waste;
solidifying the melt-extruded polyester waste by air cooling; and
crushing the solidified polyester waste to form a granulated material.

2. The method according to claim 1, wherein the melt extrusion and the solidification are performed using a plastcompactor.

3. The method according to claim 1, further comprising classifying the granulated material.

4. The method according to claim 3, further comprising reusing, in the melt extrusion, residues resulting from the classification.

5. The method according to claim 1, wherein a ratio of apparent density to bulk density (apparent density/bulk density) of the granulated material is 1.80 to 2.40.

6. The method according to claim 1, wherein the granulated material has an apparent density of 1.23 g/cm³ to 1.33 g/cm³ and a bulk density of 0.60 g/cm³ to 0.67 g/cm³.

7. The method according to claim 1, wherein the granulated material has a closed cavity therein.

8. A granulated material for chemical recycling, the granulated material comprising a compressed solidified product of a polyester waste, and
having a ratio of apparent density to bulk density (apparent density/bulk density) of 1.80 to 2.40.

9. The granulated material for chemical recycling according to claim 8, wherein the granulated material has an apparent density of 1.23 g/cm³ to 1.33 g/cm³ and a bulk density of 0.60 g/cm³ to 0.67 g/cm³.

10. The granulated material for chemical recycling according to claim 8, the granulated material having a particle size of 10 mm or less and a content of the granulated material with a particle size of 900 μm or less of 0.2% by mass or less.

11. The granulated material for chemical recycling according to claim 8, wherein the granulated material has a closed cavity therein.
